(19) United States
(12) Patent Application Publication
(10) Pub. No.: US 2013/0084893 A1
(43) Pub. Date: Apr. 4, 2013

(54) MOBILE STATION AND METHOD FOR MEASURING QUALITY OF RADIO SIGNAL

(71) Applicant: NARITOSHI SAITO, Hino (JP)

(72) Inventor: NARITOSHI SAITO, Hino (JP)

(73) Assignee: FUJITSU MOBILE COMMUNICATIONS LIMITED, Kawasaki-shi (JP)

(21) Appl. No.: 13/605,785

(22) Filed: Sep. 6, 2012

(30) Foreign Application Priority Data
Sep. 30, 2011 (JP) 2011-216849

(51) Int. Cl. H04W 24/00; H04W 68/00

(52) U.S. Cl. 455/458

(57) ABSTRACT

A mobile station includes a paging processing unit which extracts a calling signal included in radio signals and determines whether or not existing an incoming call to own mobile station by analyzing the calling signal in operation with an idle mode in which the radio signals from the base station are received during a predetermined period for every first cycle, and a signal quality measuring unit which measures quality of received radio signals for every second cycle which is two or more times the first cycle from among the radio signals received for every first cycle, but does not measure the quality of the radio signals received at a timing other than the second cycle.

### CROSS-REFERENCE TO RELATED APPLICATION

This application is based upon and claims the benefit of priority of the prior Japanese Patent Application No. 2011-216849, filed on Sep. 30, 2011, and the entire contents of which are incorporated herein by reference.

### FIELD

The embodiments discussed herein are related to a mobile station capable of being set to receive radio signals from a base station only during the transmission of specific radio signal from the base station with a predetermined cycle, and a method for measuring quality of a radio signal used by such a mobile station.

### BACKGROUND

In recent years, a mobile communication system which performs a wireless communication between a base station and a mobile station has become popular. In the mobile communication system, since a mobile station operates using electric power supplied from a built-in power supply, less power consumption by the mobile station is preferable.

Currently, a technique is utilized in which electric power supply to some circuits included in a mobile station is stopped when the mobile station is in a standby state in which data is not transmitted and received through a base station, to thereby suppress the power consumption by the mobile station (refer to, for example, Japanese Laid-open Patent Publication No. 2002-64408 and Published Japanese Translation of PCT International Publication for Patent Application (Kohyo) No. 2009-535938). According to the technique disclosed in the Japanese Laid-open Patent Publication No. 2002-64408 and Published Japanese Translation of PCT International Publication for Patent Application (Kohyo) No. 2009-535938, electric power is supplied to the circuits relevant to reception of signals only during the time the mobile station receives calling signals from a specific base station with a predetermined cycle. An operational mode of a mobile station, in which the electric power is supplied to the circuits relevant to the reception of signals only during the times when calling signals are received, is referred to as an idle mode in Worldwide Interoperability for Microwave Access (WiMAX), which is one of the standards regarding wireless communication technology, for example.

### SUMMARY

As the power consumption of a mobile station decreases, available time increases or a power supply embedded in a mobile station can be miniaturized. Therefore, there is a need to reduce the power consumption in a mobile station.

According to one embodiment, a mobile station communicating with a base station by radio is provided. The mobile station includes a paging processing unit which extracts a calling signal included in radio signals and determines whether or not existing an incoming call to the mobile station by analyzing the calling signal in operation with an idle mode in which the radio signals from the base station are received during a predetermined period for every first cycle, and a signal quality measuring unit which measures quality of received radio signals for every second cycle which is two or more times the first cycle from among the radio signals received for every first cycle, but does not measure the quality of the radio signals received at a timing other than the second cycle.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a schematic diagram of a mobile station according to one embodiment.

FIG. 2 is a schematic diagram of an example of a frame.

FIG. 3 is a schematic diagram of a data communication device.

FIG. 4A is a drawing illustrating an example of the relation between the receiving timing of calling signals and the timing of quality measurement of radio signals when a processor is not in a suspend state.

FIG. 4B is a drawing illustrating an example of the relation between the receiving timing of calling signals and the timing of quality measurement of radio signals when a processor is in a suspend state.

FIG. 5 is an operational flowchart of a reception process of a radio signal in operation with an idle mode.

### DESCRIPTION OF EMBODIMENTS

Hereinafter, a mobile station according to one embodiment will be explained with reference to accompanying drawings.

The mobile station according to the conventional technique in operation with the idle mode measures quality of a radio signal each time the mobile station receives the radio signal including a calling signal. For example, a mobile station which complies with a mobile WiMAX measures Receive Signal Strength Indication (RSSI) or Carrier-to-Interference-plus—Noise Ratio (CINR), as an index indicating the quality of the radio signal. The measured quality of the radio signal is presented on a display included in the mobile station by a sign indicating a receiving state of the radio signal, such as a so-called antenna mark, in order to notify a user of the signal quality, for example. A cycle for receiving the calling signal is set to 1.28 seconds, for example. Hereinafter, a receiving cycle of the calling signal is referred to as a paging cycle.

In the idle mode, a measurement result of the quality of the radio signal is only utilized to mainly notify the user. Therefore, even if the mobile station does not measure the quality of the radio signal at a short interval such as the paging cycle, such measurement does not affect the operation of the mobile station.

The mobile station disclosed in this specification measures the quality of the radio signal received from the base station with a cycle two or more times longer in duration than the paging cycle in operation with the idle mode. This mobile station reduces the number of times of measurement of the quality of the radio signal, to thereby reduce power consumption. Furthermore, when a main control unit which controls entire mobile station is in a suspend state, this mobile station does not measure the quality of the radio signal even if the radio signal including the calling signal is received, to thereby further reduce the power consumption.

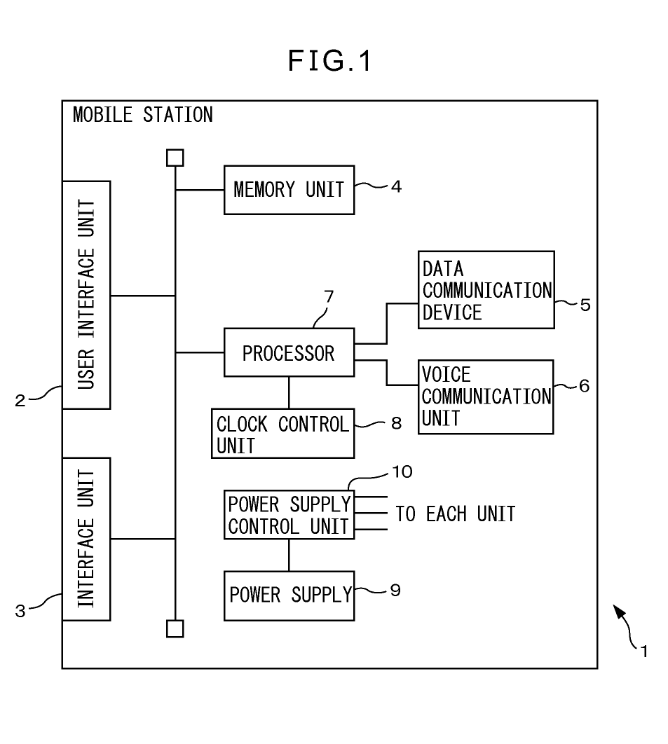

FIG. 1 is a schematic diagram of the mobile station 1 according to one embodiment. The mobile station 1 is a portable wireless terminal which operates with the electric power supplied from a built-in power supply, such as a so-called smartphone, a personal digital assistant, a mobile router, or a tablet PC. The mobile station 1 includes a user interface unit 2, an interface unit 3, a memory unit 4, a data communication device 5, a voice communication unit 6, a processor 7, a clock control unit 8, a power supply 9, and a power supply control unit 10. Each of these units included in the mobile station 1 is accommodated in a housing (not illustrated). The user interface unit 2, the interface unit 3 and the memory unit 4 are connected with the processor 7 through a data bus and a control line, for example. Moreover, the data communication device 5 and the voice communication unit 6 both are connected with the processor 7 through a General Purpose Input/Output (GPIO) terminal and a Secure Digital Input/Output (SDIO) terminal. The mobile station 1 may further include a speaker, a microphone and a camera. Note that it is not necessary to include the voice communication unit 6 in cases where the mobile station 1 is the tablet PC or the mobile router.

The user interface unit 2 includes, for example, a display such as a liquid crystal display and an input device provided with a plurality of button switches. Alternatively, the user interface unit 2 may include a touch-panel display in which the display and the input device are integrated. The user interface unit 2 displays the information for display received from the processor 7 on the display. Moreover, the user interface unit 2 transfers, to the processor 7, an input signal according to user's operation to the input device.

The interface unit 3 connects the mobile station with other equipment such as a computer or a printer, for example. To achieve this matter, the interface unit 3 includes an interface circuit in conformity with a serial bus standard such as Universal Serial Bus (USB) which supports High Speed mode, for example. The interface unit 3 outputs a data signal, such as an image signal received from the processor 7, to other equipment connected to the interface unit 3. Alternatively, the interface unit 3 transfers the data signal received from other equipment to the processor 7.

The memory unit 4 includes a non-volatile semiconductor memory circuit and a volatile semiconductor memory circuit, for example. The memory unit 4 stores various application programs to be executed on the mobile station 1, various kinds of data received by the mobile station and so on.

The data communication device 5 includes a circuit for performing a data communication by radio in packet unit between the mobile station 1 and the base station for the data communication (not illustrated). In this embodiment, the data communication device 5 performs a wireless communication with the base station in conformity with mobile WiMAX specified as IEEE 802.16e-2005 or WiMAX2 specified as IEEE 802.16m. When the mobile station 1 is performing the data communication, the data communication device 5 transmits the radio signal including the data signal received from the processor 7 to the base station, and on the other hand, the data communication device 5 extracts the data signal from the radio signal received from the base station and transfers the extracted signal to the processor 7.

The data communication device 5 can operate autonomously to the processor 7. Therefore, the data communication device 5 can operate not only when the mobile station 1 is in a normal state in which entire mobile station can operate, but also when the mobile station 1 is in the suspend state in which the mobile station only performs minimum function capable of returning to the last normal state. The details of the data communication device 5 will be described later.

The voice communication unit 6 communicates by radio between the mobile station 1 and the base station for a voice call (not illustrated). To achieve this matter, the voice communication unit 6 includes a circuit for wireless communication which operates in conformity with a standard for a mobile system, such as Wideband Code Division Multiple Access (W-CDMA) or CDMA2000 IX, for example. When the mobile station 1 is performing the voice communication, the voice communication unit 6 transmits the radio signal including the voice signal received from the processor 7 to the base station, and on the other hand, the voice communication unit 6 extracts the voice signal from the radio signal received from the base station and transfers the extracted signal to the processor 7.

The processor 7 is an example of a main control unit and controls entire mobile station 1. Moreover, the processor 7 executes the application program in accordance with an input signal by a user's operation, for example. When the processor 7 performs the data communication by radio in accordance with the application program, the processor 7 receives the data included in the radio signal from the base station through the data communication device 5. The processor 7 transfers the data to be transmitted to the base station to the data communication device 5. Moreover, the processor 7, during the voice call, transfers the voice signal which is input through the microphone to the voice communication unit 6, and on the other hand, the processor 7 receives the voice signal included in the radio signal, which is received from the base station, from the voice communication unit 6.

Furthermore, the processor 7 determines whether or not it transits to the suspend state in order to reduce the power consumption by the mobile station 1. In the suspend state, the electric power supply to the display of the user interface unit 2 is stopped, for example. Moreover, the processor 7 also stops processes other than a process for determining whether or not the processor 7 returns from the suspend state to the normal state just before starting the suspend state.

For example, the processor 7 transits to the suspend state when all of following conditions (i) through (v) are satisfied.

(i) There is no input signal from the user interface unit 2 over a predetermined period.

(ii) The information to be displayed on the user interface unit 2 does not change over a predetermined period.

(iii) There is no running application program on the processor 7.

(iv) It is not under the voice call through the voice communication unit 6.

(v) It is not under the data communication through the data communication device 5.

Note that the predetermined period may be set to any period between 5 minutes and 10 minutes, for example. Moreover, in cases where the mobile station 1 does not include the voice communication unit 6, the condition (iv) may be excluded among the above-mentioned conditions for the processor 7 to transit to the suspend state.

Moreover, in the case where the processor 7 is in the suspend state, when specific operations are applied, for example when the user touches the user interface unit 2 or pushes a specific button, the processor 7 returns to the normal state. Also when the data communication device 5 or the voice communication unit 6 is notified from the base station that there is an incoming call addressed to own mobile station, the processor 7 returns to the normal state.

The clock control unit 8 includes an oscillating circuit with variable oscillation cycle and supplies a clock signal in which the clock frequency in the normal state is different from the clock frequency in the suspend state to the processor 7, for example. The clock frequency in the normal state may be from hundreds of megahertz to one gigahertz, for example. The clock control unit 8 makes the clock frequency slower than the clock frequency in the normal state when notified from the processor 7 to transit to the suspend state. Moreover, the clock control unit 8 changes the clock frequency into the frequency in the normal state when notified from the processor 7 to return from the suspend state to the normal state.

The power supply 9 is a power supply embedded in the mobile station 1, such as a lithium ion battery. The electric power supplied from the power supply 9 is supplied to each unit of the mobile station 1 through the power supply control unit 10.

The power supply control unit 10 includes a switching circuit for switching to supply the electric power supplied from the power supply 9 to each unit of the mobile station 1 or to stop the power supply, in accordance with a control signal from the processor 7. For example, in the normal state, the power supply control unit 10 supplies the electric power to all power-supply-required units among respective units of the mobile station 1. On the other hand, in the suspend state, the power supply control unit 10 supplies the electric power only to units required for returning to the normal state among respective units of the mobile station 1.

Next, the data communication device 5 will be explained. The data communication device 5 receives the radio signals including the downlink signals, which are multiplexed in accordance with Orthogonal Frequency Division Multiple Access (OFDMA) manner, from the base station for data communication. On the other hand, the data communication device 5 transmits the radio signals including the uplink signals which are multiplexed in accordance with Orthogonal Frequency Division Multiplexing (OFDM) manner. The data communication device 5 and the base station transmit and receive the radio signal including the downlink signal and the radio signal including the uplink signal alternately in frame, for example, in accordance with Time Division Duplexing (TDD) manner.

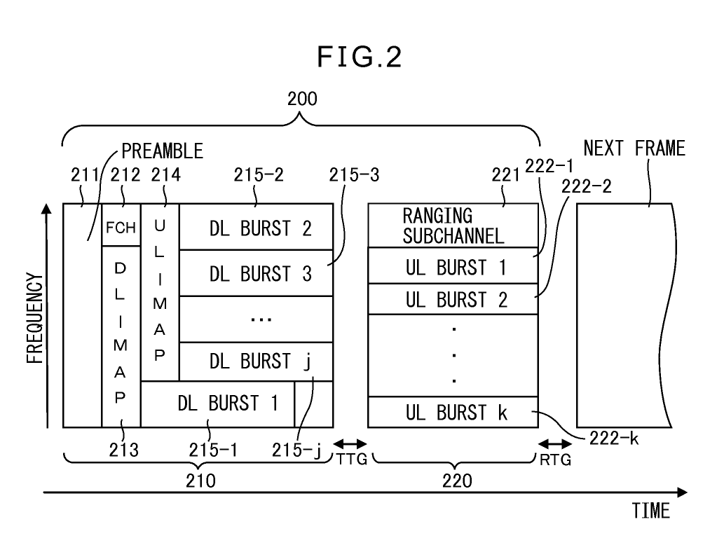

FIG. 2 is a schematic diagram of an example of a frame. In FIG. 2, a horizontal axis expresses time and a vertical axis expresses frequency. The frame 200 includes a subframe 210 for downlink transmitted to the mobile station 1 from the base station, and a subframe 220 for uplink transmitted to the base station from the mobile station 1. The subframe 210 and the subframe 220 are separated by Transmit Transition Gap (TTG) and Receive Transition Gap (RTG). The length of one frame 200 may be 5 milliseconds, for example.

The subframe 210 for downlink includes a preamble 211, a Frame Control Header (FCH) 212, a downlink map (DL-MAP) 213, an uplink map (UL-MAP) 214, and a plurality of downlink bursts 215-1 to 215-j (j is an integer greater than or equal to 2).

The preamble 211 includes a symbol which is known by the mobile station 1. The preamble 211 is utilized in order that the mobile station 1 performs a synchronous process or measures the quality of the radio signal, for example. The FCH 212 includes information indicating the length of the DL-MAP message, a manner of error correcting coding currently used and so on. The DL-MAP 213 includes information indicating synchronous information on a physical layer, an identifier of the base station, the number of OFDM symbols included in the subframe 210 for downlink, and whether each downlink burst include data or control information. The UL-MAP 214 includes information indicating a starting position of the subframe 220 for uplink in the frame, the number of OFDM symbols included in the subframe 220, and whether each uplink burst include data or control information. Each downlink burst represents a block of data to be transmitted to the mobile station 1 from the base station. For example, the calling signal is included in any of the downlink bursts.

On the other hand, the subframe 220 for uplink includes a ranging subchannel 221 and a plurality of uplink bursts 222-1 to 222-k (k is an integer greater than or equal to 2). The ranging subchannel 221 includes information regarding a ranging or a band request. Each uplink burst represents a block of data to be transmitted to the base station from the mobile station 1.

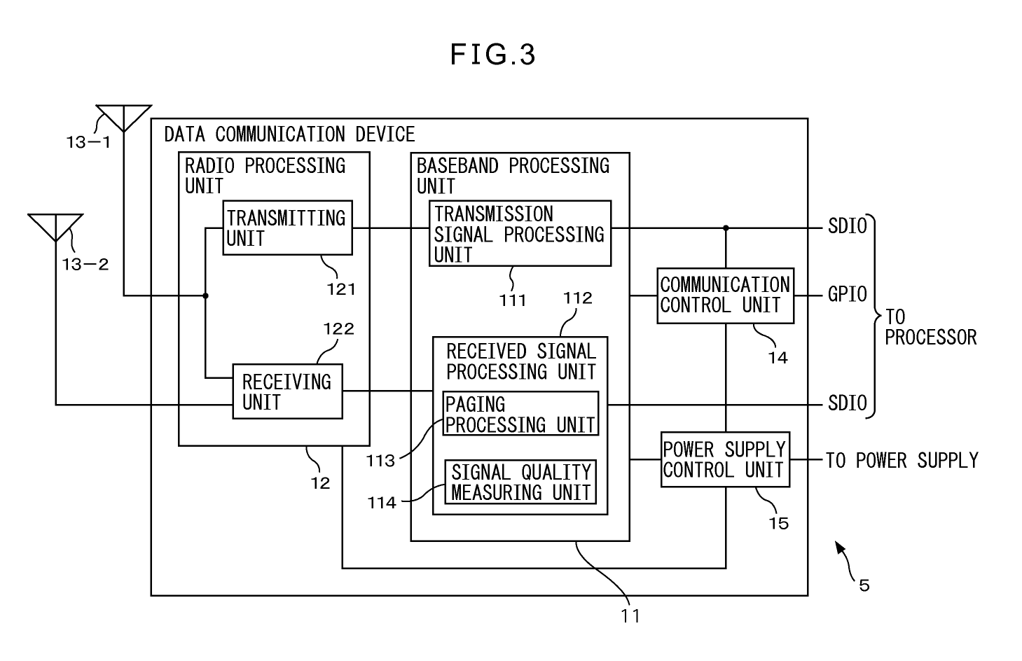

FIG. 3 is a schematic diagram of the data communication device 5. The data communication device 5 includes a baseband processing unit 11, a radio processing unit 12, two antennas 13-1, 13-2, a communication control unit 14, and a power supply control unit 15. The baseband processing unit 11, the radio processing unit 12, the communication control unit 14, and the power supply control unit 15 may be individual circuits respectively. Alternatively, each of those units may be one integrated circuit in which those circuits are integrated.

The baseband processing unit 11 performs a process to the uplink signals and the downlink signals with baseband frequency. To achieve this matter, the baseband processing unit 11 includes a transmission signal processing unit 111 which processes the uplink signals, and a received signal processing unit 112 which processes the downlink signals.

The transmission signal processing unit 111 performs the transmission process to the uplink signals, for example a coding process for error corrections such as a convolutional coding or a turbo coding. Furthermore, the transmission signal processing unit 111 modulates the coded uplink signals in accordance with a predetermined modulation method and multiplexes the uplink signals in accordance with the OFDM manner. Whereby, the transmission signal processing unit 111 generates the subframe for uplink described above. The transmission signal processing unit 111 outputs the subframe for uplink to the first radio processing unit 12.

The received signal processing unit 112 demodulates each downlink signal included in the subframe for downlink which is received from the radio processing unit 12. The received signal processing unit 112 applies an error correction decoding process to the demodulated downlink signal. The received signal processing unit 112 outputs the decoded downlink signal to the processor 7.

In addition, the base station may transmit the downlink signals from a plurality of antennas in accordance with Multiple input multiple output (MIMO) technique. In this case, the received signal processing unit 112 performs a signal separation process in accordance with, for example, a minimal mean squared error method or a maximum likelihood estimate method to a set of the downlink signals received simultaneously by the antennas 13-1 and 13-2 respectively, before demodulating each of downlink signals.

Furthermore, the received signal processing unit 112 includes a paging processing unit 113 performing a paging process which determines whether or not the incoming call addressed to own mobile station exists in operation with the idle mode, and a signal quality measuring unit 114 measuring the quality of the radio signal received from the base station.

If notified from the communication control unit 14 that the mobile station has woken up and is starting the electric power supply, the paging processing unit 113 extracts the calling signal from the subframe for downlink included in the radio signal which is received from the base station. Then, the paging processing unit 113 determines whether or not the incoming call addressed to own mobile station exists by analyzing the calling signal. For example, the calling signal may be a MOB-PAG-ADV message transmitted through a broadcast channel in the mobile WiMAX or WiMAX 2. The paging processing unit 113 extracts, among from the Media Access Control (MAC) address hash values of the mobile station included in the MOB-PAG-ADV message, a MAC address hash value corresponding to own mobile station. Then, the paging processing unit 113 determines whether or not the incoming call addressed to own mobile station exists with reference to an action code corresponding to the extracted MAC address hash value. The paging processing unit 113 notifies the communication control unit 14 of the determination result.

The signal quality measuring unit 114 measures the quality of the radio signal received from the base station apparatus at a timing instructed from the communication control unit 14, for example. The signal quality measuring unit 114 measures, in operation with the idle mode, the quality of the radio signal from the base station managing a cell to which the mobile station 1 belongs. The signal quality measuring unit 114 may measure, in operation with the active mode, not only the quality of the radio signal from the base station managing the cell to which the mobile station 1 belongs, but also the quality of the radio signal from a base station managing a cell adjacent thereto. In this embodiment, the signal quality measuring unit 114 obtains RSSI and CINR as an index indicating the quality of the radio signal. The signal quality measuring unit 114 may obtain a signal-to-interference-plus-noise ratio instead of CINR as the index indicating the quality of the radio signal received from the base station.

The signal quality measuring unit 114 measures intensities of the preamble signals included in a plurality of frames for signal quality measurement respectively, and obtains an average value of the intensities as RSSI.

Moreover, the signal quality measuring unit 114 measures the electric power of the preamble signals included in a plurality of frames for signal quality measurement respectively, and all signal powers within a period in which the preamble signals are received. The signal quality measuring unit 114 subtracts the electric power of the preamble signals from all the signal powers to obtain the electric power of an interference component and a noise component. The signal quality measuring unit 114 divides the electric power of the preamble signals by the electric power of the interference component and the noise component to obtain CINR.

Furthermore, the signal quality measuring unit 114 may apply smoothing to CINR in a direction of time axis in accordance with the following equation.

CINR_{avg}=(1−α)·CINRₜ₋₁+α·CINR_{avg}, (1)

CINRₜ is a CINR value at the time of the newest measurement, and CINRₜ₋₁ is a CINR value at the time of a measurement which is just before the newest measurement. α is a forgetting factor and is set, for example, to 0.2-0.4. CINR_{avg} is a value of smoothed CINR. In this way, applying the smoothing to CINR and outputting the smoothed CINR value to the communication control unit 14 allows the signal quality measuring unit 114 to suppress a variation in the CINR value due to a measurement error. As a result, it is also suppressed that the index indicating a receiving state which is displayed on the display of the user interface unit 2 included in the mobile station 1 changes rapidly due to the measurement error of CINR.

The signal quality measuring unit 114 notifies the communication control unit 14 of the measured values of RSSI and CINR.

The radio processing unit 12 includes a transmitting unit 121 and a receiving unit 122.

The transmitting unit 121 applies digital/analog conversion to the subframe for uplink received from the transmission signal processing unit 111 of the baseband processing unit 11, and then superimposes the subframe on a carrier with a radio frequency. The transmitting unit 121 amplifies the subframe for uplink superimposed on the carrier by a high power amplifier (not illustrated), then outputs the subframe to the antenna 13-1 through a duplexer (not illustrated). The antenna 13-1 radiates the subframe for uplink as the radio signal.

The receiving unit 122 receives the radio signal including the subframe for downlink which is received by the antenna 13-1 through the duplexer. The receiving unit 122 also receives the radio signal including the subframe for downlink received by the antenna 13-2. Thereafter, the receiving unit 122 selects the subframe of which signal intensity is stronger among from the subframes for downlink received from the two antennas respectively. The receiving unit 122 amplifies the selected subframe by a low noise amplifier and superimposes periodic signal with local oscillation frequency on the amplified subframe, whereby, the receiving unit 122 converts the frequency of the subframe for downlink into baseband frequency from radio frequency. The receiving unit 122 applies the analog/digital conversion to the subframe for downlink with the baseband frequency, and then transfers the subframe to the received signal processing unit 112 of the baseband processing unit 11.

Alternatively, the base station may transmit the subframe for downlink from a plurality of antennas in accordance with MIMO technique. In this case, the receiving unit 122 performs the amplification, the frequency conversion and the analog/digital conversion to the subframes for downlink received by the antennas respectively. Subsequently, the receiving unit 122 transfers processed subframe to the received signal processing unit 112.

The communication control unit 14 includes at least one processor and a memory. The communication control unit 14 performs a connection setting process in accordance with the procedure defined in mobile WiMAX or WiMAX2, when the mobile station 1 starts the wireless communication with the base station. The communication control unit 14 performs handover, transmission power control, a determination process of the modulation manner for the uplink signal and so on, in operation with the active mode which is a state where data is being transmitted and received between the mobile station 1 and the base station.

Furthermore, the communication control unit 14 performs a transit process to the idle mode in accordance with the procedure defined in mobile WiMAX or WiMAX2, when receiving the control signal for transiting to the idle mode from the processor 7 or the base station. Specifically, the communication control unit 14 transmits a deregistration request (DREG-REQ) message to the base station and receives a deregistration command (DREG-CMD) message from the base station, whereby, the communication control unit 14 exchanges information required for the operation in the idle mode with the base station. Thereafter, the communication control unit 14 starts the operation in the idle mode.

In operation with the idle mode, the communication control unit 14 causes the paging processing unit 113 to perform the paging process. Moreover, in operation with the idle mode, the communication control unit 14 causes the signal quality measuring unit 114 to measure the quality of the radio signal received from the base station only when the processor 7 is not in the suspend state.

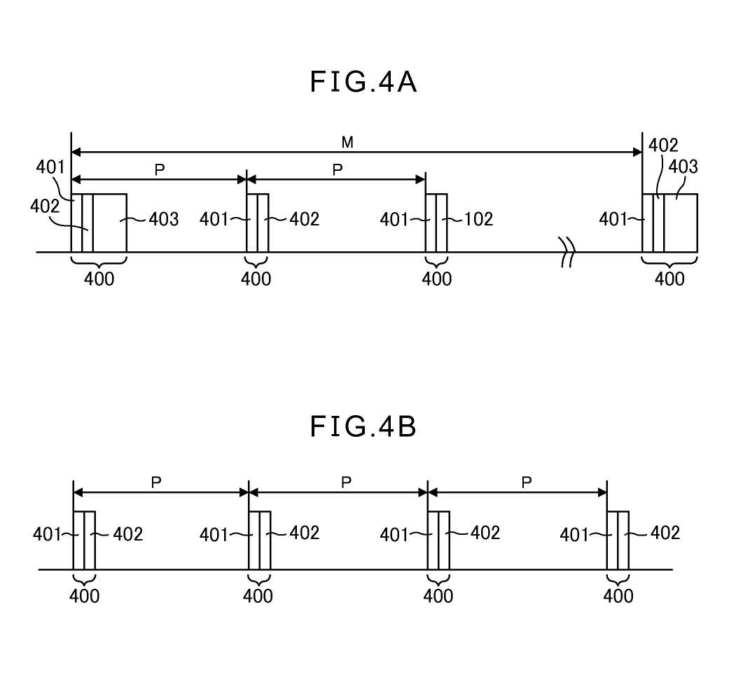

FIG. 4A is a drawing illustrating an example of the relation between the receiving timing of the calling signals and the timing of quality measurement of the radio signals when the processor 7 is not in the suspend state. FIG. 4B is a drawing illustrating an example of the relation between the receiving timing of the calling signals and the timing of quality measurement of the radio signals when the processor 7 is in the suspend state. In the FIG. 4A and FIG. 4B, a horizontal axis expresses time.

As illustrated in FIG. 4A, when the processor 7 is not in the suspend state, the mobile station 1 receives the radio signals 400 including a plurality of subframes for downlink, for every paging cycle P negotiated with the base station in advance during a listening interval also negotiated with the base station in advance. Each radio signal 400 includes a synchronization frame 401 including a subframe used for a synchronous process and a paging frame 402 including the calling signal.

The paging processing unit 113 performs, for example, the synchronous process based on the preamble included in the synchronization frame 401 when receiving the radio signal 400. The paging processing unit 113 specifies the burst including the calling signal with reference to DL-MAP in the subframe for downlink included in the paging frame 402. The paging processing unit 113 analyzes the calling signal and determines whether or not the incoming call addressed to own mobile station exists, as described above.

Furthermore, the mobile station 1 receives a plurality of frames 403 for measurement, which follows the paging frame 402 and is used for the quality measurement of the radio signal, from the downlink signals 400 for every measurement period M which is two or more times the paging cycle P. For example, if the paging cycle P is 1.28 seconds, the measurement period M is set to 5.12 seconds which are 4 times the paging cycle P or is set to 10.24 seconds which are 8 times the paging cycle P. The signal quality measuring unit 114 measures the quality of the received radio signal based on the preamble in the subframe for downlink included in the frame 403 for measurement, for example.

As illustrated in FIG. 4B, also when the processor 7 is in the suspend state, the mobile station 1 receives the radio signals 400 each of which includes the synchronization frame 401 and the paging frame 402 for every paging cycle P negotiated with the base station in advance. The paging processing unit 113 determines whether or not the incoming call addressed to own mobile station exists, each time the mobile station receives the radio signal 400. However, in this case, the communication control unit 14 causes the signal quality measuring unit 114 to stop the quality measurement of the received radio signal.

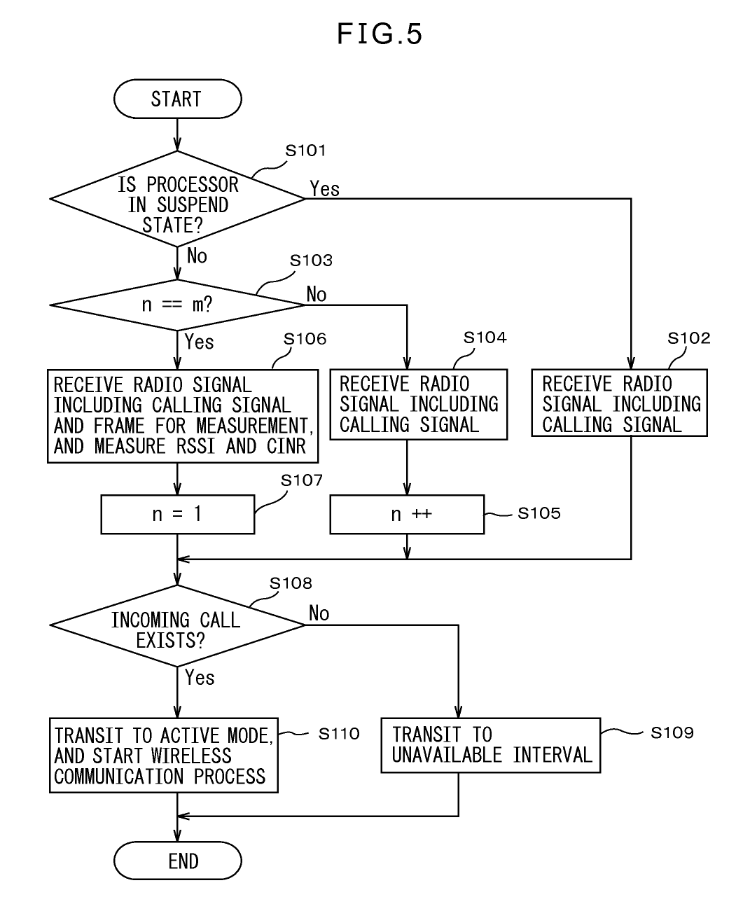

FIG. 5 is an operational flowchart of a reception process of the radio signal in operation with the idle mode, which is an example of a radio signal measurement process controlled by the communication control unit 14. The communication control unit 14 performs this reception process each time the paging cycle P has elapsed.

The communication control unit 14 determines whether or not the processor 7 is in the suspend state (step S101). For example, the communication control unit 14 stores a suspend flag indicating that the processor 7 is in the suspend state into the memory of the communication control unit 14, if the communication control unit 14 has received suspend information for notifying that the processor 7 has transited to the suspend state from the processor 7 through the GPIO terminal. Thereafter, the communication control unit 14 determines that the processor 7 is in the suspend state if the suspend flag is stored in the memory. Moreover, the communication control unit 14 deletes the suspend flag, for example when the communication control unit 14 receives information for notifying that the processor has then returned to the normal state from the processor 7 through the GPIO terminal.

In cases where a register for communication (not illustrated) connected with the communication control unit 14 and the processor 7 is provided therebetween, the communication control unit 14 may determine whether or not the processor 7 is in the suspend state by whether or not there is any signal to be received from the processor 7 through the SDIO terminal. For example, the processor 7 accesses the register for communication for every predetermined period in the normal state, and if a certain command has been written in the register for communication from the communication control unit 14, the processor 7 reads the command from the register for communication. The processor 7 sends an interrupt request signal to the communication control unit 14 through the SDIO terminal connected with the communication control unit 14 in accordance with the read command. On the other hand, in the suspend state, the processor 7 does not access the register for communication. Therefore, even if a predetermined period has elapsed after writing the command into the register for communication, the communication control unit 14 can determine that the processor 7 is in the suspend state unless the interrupt request signal is received from the processor 7.

When the processor 7 is in the suspend state (step S101—Yes), the communication control unit 14 causes the receiving unit 122 of the radio processing unit 12 and the received signal processing unit 112 of the baseband processing unit 11 to wake up and receives the radio signal including the calling signal from the base station (step S102). Thereafter, the paging processing unit 113 of the received signal processing unit 112 analyzes the calling signal, and if the incoming call addressed to own mobile station exists, the paging processing unit 113 notifies the communication control unit 14 of the fact.

On the other hand, if the processor 7 is not in the suspend state (step S101—No), the communication control unit 14 determines whether or not the value n of a counter which counts the number of times of reception of the calling signal is equal to the number of times m corresponding to the measurement period M. When n is different from m (step S103—No), the communication control unit 14 causes the receiving unit 122 and the received signal processing unit 112 to wake up and receives the radio signal including the calling signal from the base station (step S104). Thereafter, the paging processing unit 113 analyzes the calling signal, and if the incoming call addressed to own mobile station exists, the paging processing unit 113 notifies the communication control unit 14 of the fact. Moreover, the communication control unit 14 increments the value n by 1 (step S104).

On the other hand, when n is equal to m (step S103—Yes), the communication control unit 14 causes the receiving unit 122 and the received signal processing unit 112 to wake up and receives the radio signal including the calling signal and the frame for measurement from the base station (step S106). Thereafter, the signal quality measuring unit 114 measures RSSI and CINR based on the preamble in the subframe for downlink included in the frame for measurement and the like, and notifies the communication control unit 14 of the measurement result. The paging processing unit 113 analyzes the calling signal, and if the incoming call addressed to own mobile station exists, the paging processing unit 113 notifies the communication control unit 14 of the fact. Thereafter, the communication control unit 14 resets the value n to 1 (step S107).

After the step S102, S105 or S107, the communication control unit 14 determines whether or not it has notified that the incoming call addressed to own mobile station exists (step S108).

If there is no incoming call (step S108—No), the communication control unit 14 transits to unavailable interval in which the radio signal from the base station cannot be received, and stops the power supply to the receiving unit 122 and the received signal processing unit 112 (step S109). On the other hand, if there is the incoming call (step S108—Yes), the communication control unit 14 transits to the active mode (step S110). Thereafter, the communication control unit 14 starts a wireless communication process.

The communication control unit 14 ends the reception process after the step S109 or S110.

The power supply control unit 15 includes a switching circuit for switching to supply the electric power supplied from the power supply 9 to each unit of the data communication device 5 or to stop the power supply, in accordance with the control signal from the communication control unit 14. For example, in the active mode, the power supply control unit 15 supplies the electric power supplied from the power supply 9 to all power-supply-required units among the units in the data communication device 5.

On the other hand, in operation with the idle mode and in the period of the listening interval, the power supply control unit 15 supplies the electric power only to each unit required for receiving the radio signal including the calling signal and performing the paging process, that is, to the communication control unit 14, the receiving unit 122 and the received signal processing unit 112. However, it is not necessary to supply the electric power to the signal quality measuring unit 114 by the power supply control unit 15 at a timing at which the signal quality is not measured, even in the period of the listening interval.

Moreover, the power supply control unit 15 may supply the electric power only to the communication control unit 14 in operation with the idle mode and in the period of unavailable interval.

The data communication device 5 may also include a clock control unit (not illustrated). In this case, the clock control unit may make the frequency of a clock signal, which is supplied to each unit of the data communication device 5 during the unavailable interval, slower than the frequency of a clock signal which is supplied to each unit during the period of the listening interval or in operation with the active mode.

As explained above, when the data communication device is in operation with the idle mode and the processor is not in the suspend state, the mobile station makes the cycle of quality measurement of the radio signal received from the base station longer than the paging cycle. Therefore, the mobile station allows a reduction in the number of times quality measurement of the radio signal in made, and this results in suppressing the power consumption required for the process regarding the quality measurement of the radio signal. Furthermore, when the data communication device is in operation with the idle mode and the processor is in the suspend state, the mobile station does not perform the quality measurement of the radio signal. Accordingly, the mobile station can suppress the power consumption more.

Note that the present invention is not limited to the embodiments described above. For example, according to a modification, the communication control unit of the data communication device may cause the signal quality measuring unit to measure the quality of the radio signal at a cycle longer than a signal quality measurement cycle for a case the processor is not in the suspend state, when the processor is in the suspend state in operation with the idle mode. In this case, the measurement frequency of radio signal quality for a case in which the processor is in the suspend state is less than the measurement frequency of radio signal quality for a case in which the processor is not in the suspend state, therefore the communication control unit can reduce the power consumption by the data communication device in a case in which the processor is in the suspend state. Alternatively, the communication control unit may cause the signal quality measuring unit to measure the quality of the radio signal with a cycle which is two or more times the duration of the paging cycle regardless of whether the processor is in the suspend state or not, in operation with the idle mode.

According to still another modification, the data communication device may perform the wireless communication with the base station in conformity with other wireless communication standards such as Long Term Evolution (LTE). Especially, in cases where the data communication device complies with a standard capable of performing both voice communication and data communication, the data communication device may perform both voice communication and data communication. Therefore, the voice communication unit can be omitted. Also in this case, the data communication device measures the quality of the radio signal with the cycle which is two or more times the duration of the paging cycle in operation with the idle mode.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A mobile station for communicating with a base station by radio, comprising:
a paging processing unit which extracts a calling signal included in radio signals and determines whether or not there is existing an incoming call to the mobile station by analyzing the calling signal in operation with an idle mode in which the radio signals from the base station are received during a predetermined period for every first cycle; and
a signal quality measuring unit which measures quality of received radio signals for every second cycle which is two or more times the first cycle from among the radio signals received for every first cycle, but does not measures the quality of the radio signals received at a timing other than the second cycle.

2. The mobile station according to claim 1 further comprising:
a main control unit which controls the mobile station; and
a communication control unit which makes a frequency of measuring the quality of the radio signals by the signal quality measuring unit in a state where the main control unit is in a suspend state smaller than a frequency of measuring the quality of the radio signals by the signal quality measuring unit in a state where the main control unit is not in the suspend state.

3. The mobile station according to claim 2, wherein the communication control unit stops measurement of the quality of the radio signals by the signal quality measuring unit when the main control unit is in the suspend state.

4. A method for measuring quality of a radio signal received from a base station in a mobile station which communicates with the base station by radio, the method comprising:
extracting a calling signal included in radio signals and determining whether or not there is existing an incoming call to the mobile station by analyzing the calling signal in operation with an idle mode in which the radio signals from the base station are received during a predetermined period for every first cycle; and
measuring quality of received radio signals for every second cycle which is two or more times the duration of the first cycle from among the radio signals received for every first cycle, but not measuring the quality of the radio signals received at a timing other than the second cycle.
